(19) United States
(12) Patent Application Publication
(10) Pub. No.: US 2016/0059442 A1
(43) Pub. Date: Mar. 3, 2016

(54) EMBOSSING TOOL AND METHODS OF PREPARATION

(71) Applicant: E Ink California, LLC, Fremont, CA (US)

(72) Inventors: Yih-Ming KANG, Fremont, CA (US); Du Quy LE, San Jose, CA (US); Hanan LIU, Milpitas, CA (US); Yu LI, Fremont, CA (US); Donald A. Schultz, San Jose, CA (US)

(21) Appl. No.: 14/475,220

(22) Filed: Sep. 2, 2014

(51) Int. Cl. B29C 33/60; G02F 1/167; B29C 59/02

(52) U.S. Cl. CPC B29C 33/60; B29C 59/022; G02F 1/167; B29C 2059/023; B29K 2905/14; B29K 2067/003

(57) ABSTRACT

The present invention is directed to an embossing tool having a microstructure on its surface wherein the surfaces of the microstructures are overcoated with a precious metal or an alloy thereof. Such an embossing tool not only can reduce adhesion between the surface of the embossing tool and a cured material, but also does not cause any significant change to the profile of the microstructure.

### FIELD OF THE INVENTION

The invention is directed to an embossing tool and methods for its preparation.

### BACKGROUND OF THE INVENTION

Embossing tools usually are made of nickel, copper, an alloy or other types of composite materials. Nickel is the most widely-used material for embosser fabrication.

Unfortunately, there are a few problems associated with the currently available embossing tools, in particular, incomplete release of the cured material or hot embossed material from an embossing tool after embossing. There are ways to modify the surface of an embossing tool to reduce the adhesion between the surface of the embossing tool and the cured or hot embossed material. Such methods may include teflon-coating [via physical vapor deposition (PVD), chemical vapor deposition (CVD) or wet-coating], silane-coating or nickel-teflon composite plating. However none of these surface modification methods has produced satisfactory results. The teflon-coating via PVD or CVD has shown poor throwing-power and also non-uniform coverage when the microstructure on the surface of the embossing tool has a high aspect ratio. In addition, poor durability and mechanical strength of the teflon-coating is another concern, especially if an embossing tool needs to be extensively used for mass production.

Teflon coating and nickel-teflon composite coating can be applied to the surface of the embossing tool via wet-coating, electroplating or an electro-less plating process. However, the minimum coating thickness normally is several microns. Therefore if an embossing tool has a microstructure with small dimensions, especially narrow trenches, on its surface, such coating may drastically change the profile and aspect ratio of the microstructure, rendering the embossing task much more difficult.

### SUMMARY OF THE INVENTION

The present invention is directed to an embossing tool having a microstructure on its surface wherein the surfaces of the microstructures are overcoated with a precious metal or an alloy thereof.

In one embodiment, the precious metal is gold, silver, platinum, palladium, ruthenium, rhodium, osmium or iridium. In one embodiment, the precious metal is gold.

In one embodiment, the alloy comprises a precious metal and a non-precious metal selected from the group consisting of copper, tin, cobalt, nickel, iron, indium, zinc and molybdenum. In one embodiment, the total weight of the non-precious metal in the alloy is in the range of 0.001% to 50%, preferably in the range of 0.001% to 10%.

In one embodiment, the coating has a thickness in the range of 0.001 to 10 microns, preferably in the range of 0.001 to 3 microns.

One aspect of the present invention is directed to an embossing process, which comprises:

a) providing an embossing composition on a supporting layer;

b) providing an embossing tool of Claim 1;

c) embossing the embossing composition with the embossing tool;

d) curing or hot embossing the embossing composition after step c);

e) releasing the embossing tool,

wherein the adhesion between the embossing tool and the cured embossing composition or hot embossed material is weaker than the adhesion between the supporting layer and the cured embossing composition or hot embossed material.

In one embodiment, the cured embossing composition or hot embossed material is hydrophobic and the supporting layer is hydrophilic, or vice versa.

### BRIEF DESCRIPTION OF THE DRAWINGS

FIGS. 1A and 1B illustrate an embossing process.

FIG. 2 illustrates a method for forming a microstructure on the surface of an embossing tool.

FIG. 3 is a cross-section view of an embossing tool with a three-dimensional microstructure and a precious metal (e.g., gold) plating on its surface.

FIG. 4A is a photograph showing an object manufactured from an embossing process with a conventional embossing tool.

FIG. 4B is a photograph showing an object manufactured from an embossing process with an embossing tool of the present invention.

### DETAILED DESCRIPTION OF THE INVENTION

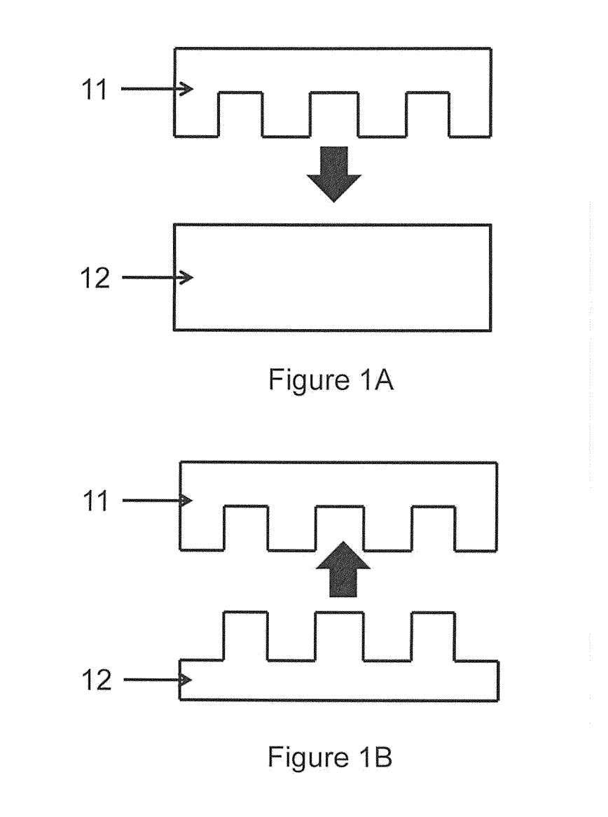

FIGS. 1A and 1B illustrate an embossing process with an embossing tool (11). As shown in FIG. 1, after the embossing tool (11) is applied to a curable embossing composition or hot-embossable material (12) to form an object, and when the embossing composition is cured (e.g., by radiation) or the hot-embossable material becomes embossed by heat and pressure, in the form of the object, the cured or hot embossed material is released from the embossing tool (see FIG. 1B). However, with a conventional embossing tool, the cured or hot embossed material sometimes does not completely release from the tool because of the adhesion between cured or hot embossed material and the surface of the embossing tool. In this case, there may be some cured or hot embossed material transferred to or stuck on the surface of the embossing tool, leaving an uneven surface on the object.

This problem is even more pronounced if the object is formed on a supporting layer, such as a transparent conductive layer or a polymeric layer. If the adhesion between the cured or hot embossed material and the supporting layer is weaker than the adhesion between the cured or hot embossed material and the surface of the embossing tool, the release process of the cured or hot embossed material from the embossing tool may cause separation of the object from the supporting layer.

In some cases, the object may be formed on a stack of layers and in this case, if the adhesion between any two of the adjacent layers is weaker than the adhesion between the cured or hot embossed material and the surface of the embossing tool, the release process of the cured or hot embossed material from the embossing tool could cause a break-down between the two layers.

The above described problems are especially a concern when the cured embossing composition or hot embossed material does not adhere well to certain supporting layers. For example, if the supporting layer is a polymeric layer, the adhesion between the polymeric layer and a cured or hot embossed embossing composition is weak if one of them is hydrophilic and the other is hydrophobic.

Suitable compositions for forming the hydrophobic embossing layer or supporting layer may comprise a thermoplastic, thermoset, or a precursor thereof. Examples of thermoplastic or thermoset precursor may be multifunctional acrylate or methacrylate, multifunctional vinyl ether, multifunctional epoxide and oligomers or polymers thereof.

Suitable compositions for forming the hydrophilic embossing layer or supporting layer may comprise a polar oligomeric or polymeric material. As described in U.S. Pat. No. 7,880,958, such a polar oligomeric or polymeric material may be selected from the group consisting of oligomers or polymers having at least one of the groups such as nitro (—NO₂), hydroxyl (—OH), carboxyl (—COO), alkoxy (—OR wherein R is an alkyl group), halo (e.g., fluoro, chloro, bromo or iodo), cyano (—CN), sulfonate (—SO₃) and the like. The glass transition temperature of the polar polymer material is preferably below about 100° C. and more preferably below about 60° C. Specific examples of suitable polar oligomeric or polymeric materials may include, but are not limited to, polyvinyl alcohol, polyacrylic acid, poly(2-hydroxylethyl methacrylate), polyhydroxy functionalized polyester acrylates (such as BDE 1025, Bomar Specialties Co, Winsted, Conn.) or alkoxylated acrylates, such as ethoxylated nonyl phenol acrylate (e.g., SR504, Sartomer Company), ethoxylated trimethylolpropane triacrylate (e.g., SR9035, Sartomer Company) or ethoxylated pentaerythritol tetraacrylate (e.g., SR494, from Sartomer Company).

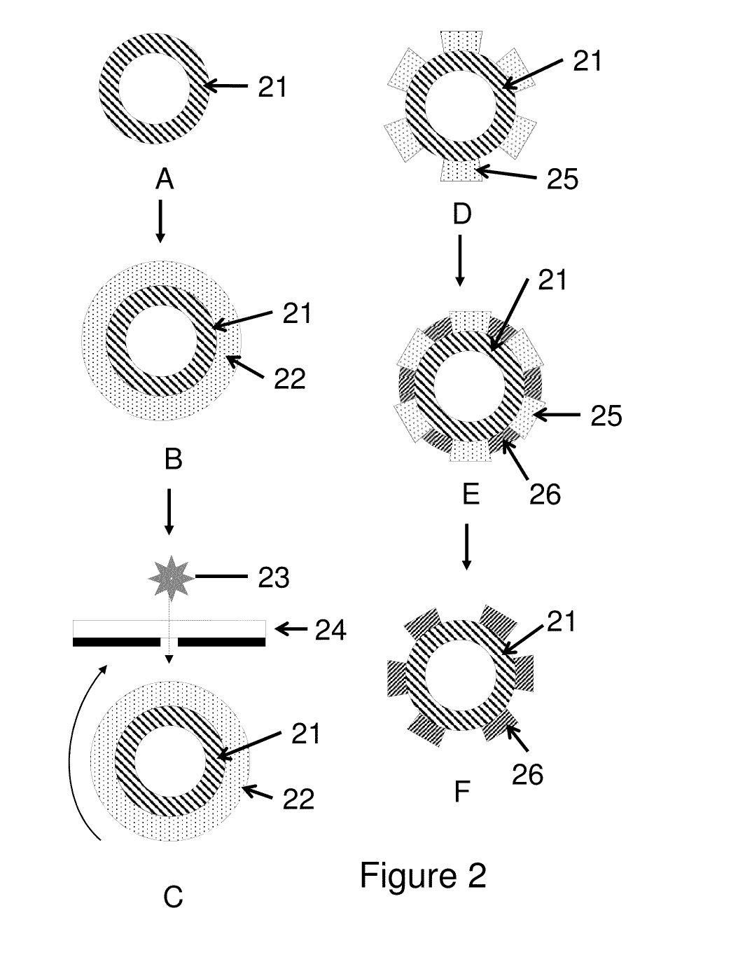

FIG. 2 illustrates one of conventional methods for forming a microstructure on the surface of an embossing tool.

The term “embossing tool”, in the context of the present application, may be an embossing sleeve or an embossing drum. While only the preparation of an embossing sleeve is demonstrated in FIG. 2, it is understood that the method can be used for the preparation of an embossing drum as well. The term “embossing” drum or sleeve refers to drums or sleeves which have a three-dimensional microstructure on its outer surface. The term “embossing drum” is used so as to distinguish it from a plain drum which does not have a three-dimensional microstructure on its outer surface.

The embossing drum may be used directly as an embossing tool. When the embossing sleeve is used for embossing, it is usually mounted on a plain drum to allow rotation of the embossing sleeve.

The embossing drum or sleeve (21) is usually formed of a conductive material, such as a metal (e.g., aluminum, copper, zinc, nickel, chromium, iron, titanium, cobalt or the like), an alloy derived from any of the aforementioned metals, or stainless steel. Different materials may be used to form a drum or sleeve. For example, the center of the drum or sleeve may be formed of stainless steel and a nickel layer is sandwiched between the stainless steel and the outermost layer which may be a copper layer.

Alternatively, the embossing drum or sleeve (21) may be formed of a non-conductive material with a conductive coating or a conductive seed layer on its outer surface. Further alternatively, the embossing drum or sleeve (21) may be formed of a non-conductive material without a conductive material on its outer surface.

Before coating a photosensitive material (22) on the outer surface of a drum or sleeve (21), as shown in the step of FIG. 2B, precision grinding and polishing may be used to ensure smoothness of the outer surface of the drum or sleeve.

In the step of FIG. 2B, a photosensitive material (22), e.g., a photoresist, is coated on the outer surface of the drum or sleeve (21). The photosensitive material may be of a positive tone, negative tone or dual tone. The photosensitive material may also be a chemically amplified photoresist. The coating may be carried out using dip, spray, drain or ring coating. The thickness of the photosensitive material is preferably greater than the depth or height of the three-dimensional microstructure to be formed. After drying and/or baking, the photosensitive material is subjected to exposure as shown in FIG. 2C. Alternatively, the photosensitive material (22) can be a dry film photoresist (which is usually commercially available) that is laminated onto the outer surface of the drum or sleeve (21).

In the step of FIG. 2C, a suitable light source (23), e.g., IR, UV, e-beam or laser, is used to expose the photosensitive material (22) coated on the drum or sleeve (21). The light source can be a continuous or pulsed light. A photomask (24) is optionally used to define the three-dimensional microstructure to be formed. Depending on the microstructure, the exposure can be step-by-step, continuous or a combination thereof.

After exposure, the photosensitive material (22) may be subjected to post-exposure treatment, e.g., baking, before development. Depending on the tone of the photosensitive material, either exposed or un-exposed areas will be removed by using a developer. After development, the drum or sleeve with a patterned photosensitive material (25) on its outer surface (as shown in FIG. 2D) may be subjected to baking or blanket exposure before deposition (e.g., electroplating, electroless plating, physical vapor deposition, chemical vapor deposition or sputtering deposition).

A variety of metals or alloys (e.g., nickel, cobalt, chrome, copper, zinc, iron, tin, silver, gold or an alloy derived from any of the aforementioned metals) can be electroplated and/or electroless plated onto the drum or sleeve. The plating material (26) is deposited on the outer surface of the drum or sleeve in areas that are not covered by the patterned photosensitive material. The deposit thickness is preferably less than that of the photosensitive material, as shown in FIG. 2E. The thickness variation of the deposit over the whole drum or sleeve area can be controlled to be less than 1%, by adjusting plating conditions, e.g., the distance between the anode and the cathode (i.e., drum or sleeve) if electroplating is used, the rotation speed of the drum or sleeve and/or circulation of the plating solution.

Alternatively, in the case of using electroplating to deposit the plating material (26), the thickness variation of the deposit over the entire surface of the drum or sleeve may be controlled by inserting a non-conductive thickness uniformer between a cathode (i.e., the drum or sleeve) and an anode, as described in U.S. Pat. No. 8,114,262, the content of which is incorporated herein by reference in its entirety.

After plating, the patterned photosensitive material (25) can be stripped by a stripper (e.g., an organic solvent or aqueous solution).

A precision polishing may be optionally employed to ensure acceptable thickness variation and degree of roughness of the deposit over the entire drum or sleeve.

FIG. 2F shows a cross-section view of an embossing drum or sleeve with a three-dimensional pattern microstructure formed thereon.

Alternatively, a three-dimensional microstructure may be formed on a flat sheet of a metal or metal alloy layer (such as nickel, or nickel cobalt alloy), according to the steps as described above. The flat metal sheet with a three-dimensional microstructure on one side is then mounted (i.e., wrapped over) a drum with the three-dimensional microstructure on the outer surface.

The present inventors have found that an embossing tool may have improved release property if the surface of the embossing tool is overcoated with a precious metal or an alloy thereof.

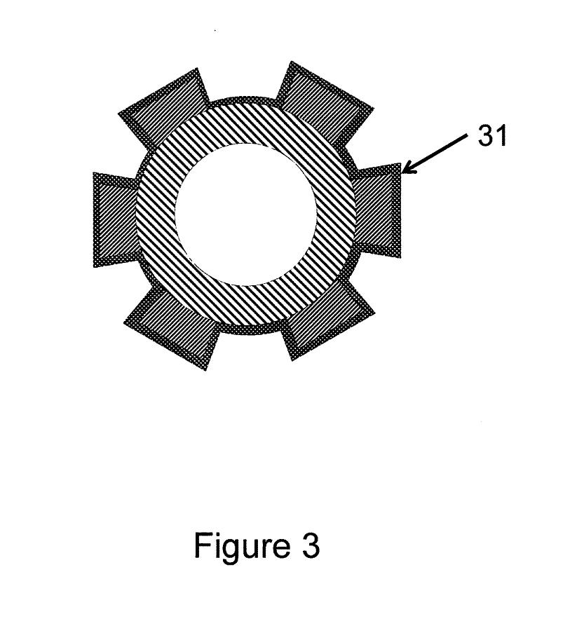

In other words, as a post-treatment step after a three-dimensional microstructure is formed on the surface of an embossing tool, a precious metal or an alloy thereof (31) may be coated over the surface of the three-dimensional microstructure, as shown in FIG. 3.

The term “precious metal”, in the context of the present invention, may include, gold, silver, platinum, palladium and other less commonly known metals, such as ruthenium, rhodium, osmium or iridium. In one embodiment, the precious metal is gold. It is also possible to have more than one precious metal mixed in a composition for coating.

An alloy of one or more precious metals and non-precious metals may also be used for the present invention. Suitable non-precious metals in an alloy may include, but are not limited to, copper, tin, cobalt, nickel, iron, indium, zinc or molybdenum. In the alloy, there may also be more than one precious metal and/or more than one non-precious metal. The total weight percentage of the non-precious metal in the alloy may be in the range of 0.001% to 50%, preferably in the range of 0.001% to 10%.

The coating of the precious metal or alloy may be accomplished by electroplating, electro-less deposition or vapor deposition. In one embodiment, cyanide-based neutral gold, acid hard gold or gold strike plating electrolytes may be used at temperatures of 30˜70° C. and in the pH range of 3˜8. Platinum and palladium may be plated with acid chloride electrolytes at temperatures of 40˜70° C. and in the pH range of 0.1˜3. Some alkaline electrolytes for precious metals or alloys thereof are commercial available and may also be used for the present invention.

The precious metal or alloy thereof on the surface preferably has a thickness in sub-microns, and therefore it does not cause any significant change to the profile of the microstructure. The thickness of the precious metal or alloy thereof may be in the range of 0.001 to 10 microns, preferably in the range of 0.001 to 3 microns.

The embossing tool of the present invention is suitable for a microembossing process as described in U.S. Pat. No. 6,930,818, the content of which is incorporated herein by reference in its entirety. The microembossing process manufactures cup-like microcells separated by partition walls such as MICROCUPS®. The microcells may be filled with an electrophoretic fluid comprising charged particles dispersed in a solvent or solvent mixture. The filled microcells form an electrophoretic display film. The electrophoretic display film, when sandwiched between electrode layers, forms an electrophoretic device.

### EXAMPLE 1

In this example, two embossing tools (i.e., male molds) were prepared. The molds were formed of nickel, according to one of the methods as described above. One of the nickel molds formed was further electroplated with a cyanide-based gold plating electrolyte operated at temperature of 50° C. and pH 5, to achieve a gold coating having a thickness of 0.5 micron.

For testing of the two embossing molds, a water-based polymer layer fluid and an embossing composition were prepared. The polymer layer fluid was prepared according to U.S. Pat. No. 7,880,958, and it had polyvinyl alcohol as a major component. The embossing composition was prepared according to U.S. Pat. No. 7,470,386, and it had multi-functional acrylate as a major component.

The polymer fluid was first coated on a PET (polyethylene terephthalate) substrate using a #3 Meyer drawdown bar. The dried polymer layer had a thickness of 0.5 micron.

The embossing composition was diluted with MEK and then coated onto the polymer-coated PET with a targeted dry thickness of 25 microns. The coating was dried and embossed with the embossing molds at 160° F. under a pressure of 50 psi, with UV exposure (0.068 J/cm², Fusion UV, D lamp) through the back of the PET substrate.

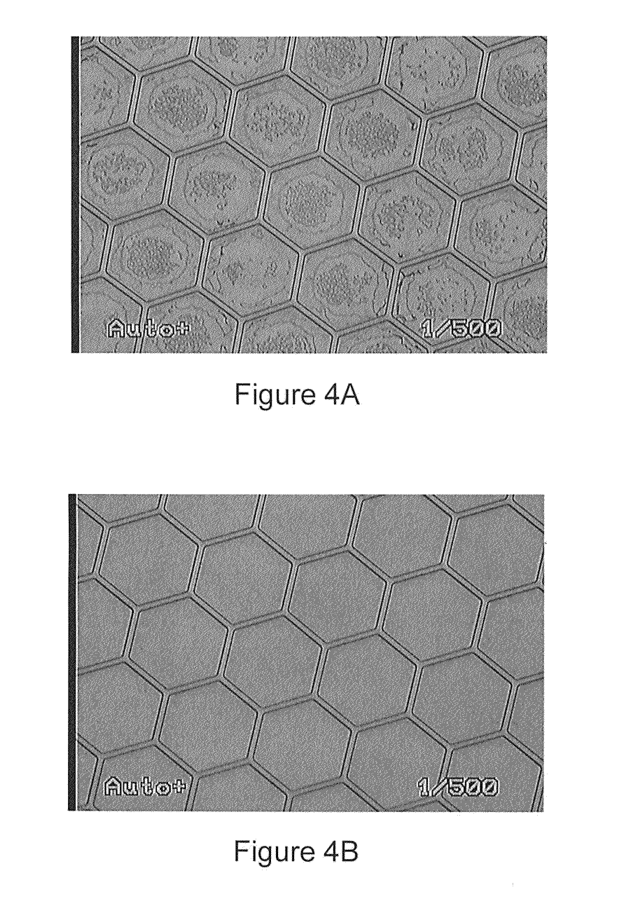

After curing, the embossed PET film was peeled off from embossing molds. FIG. 4A is the microscopic photograph of the resulting film prepared by using the nickel embossing mold. It can be seen that some of the polymer layer and/or cured materials on the resulting film had been transferred to or stuck on the nickel mold because of the strong adhesion between the cured material and the nickel metal.

With the gold plated nickel mold, the cured embossing material was completely separated from the gold metal surface, as shown in FIG. 4B. This is due to the fact that the gold-plated surface had decreased the adhesion between the mold surface and the cured material, rendering the release of the mold from the cured material much easier.

### EXAMPLE 2

In this example, several embossing tools (i.e., male molds) were prepared. The molds were formed of nickel, according to one of the methods as described above. One of the nickel molds formed was further electroplated with 0.5 micron of gold with the same electrolyte bath as that used in Example 1.

For silane treatment, polydimethylsiloxane (Gelest, Inc.) was added into 95% n-propyl alcohol-5% DI water solution which was prior adjusted to pH 4.5 with acetic acid. Polydimethylsiloxane solutions of concentrations of 0.25%, 1% and 2 wt %, respectively, were prepared. Nickel molds were immersed into the silane solutions for 10 min and then baked at 100° C. overnight to achieve a silane coating on the surface of microstructure.

The embossing testing materials and conditions were the same as those used in Example 1. With the gold plated nickel mold, all of the cured embossing material was completely separated from the gold metal surface. However, more than about 50% of the area of the cured embossing material on the resulting films had been transferred to or stuck on the silane-treated nickel mold surface, regardless of the polydimethylsiloxane concentrations in the treatment solution.

This example shows that the cured material can be easier to be released from gold plated surface than silane treated surface.

Although the foregoing invention has been described in some detail for purposes of clarity of understanding, it will be apparent that certain changes and modifications may be practiced within the scope of the appended claims. It should be noted that there are many alternative ways of implementing both the process and apparatus of the present invention. Accordingly, the present embodiments are to be considered as illustrative and not restrictive, and the invention is not to be limited to the details given herein, but may be modified within the scope and equivalents of the appended claims.

What is claimed is:

1. An embossing tool having a microstructure on its surface wherein the surfaces of the microstructures are overcoated with a precious metal or an alloy thereof.

2. The tool of claim 1, wherein the precious metal is gold, silver, platinum, palladium, ruthenium, rhodium, osmium or iridium.

3. The tool of claim 1, wherein the precious metal is gold.

4. The tool of claim 1, wherein the alloy comprises a precious metal and a non-precious metal selected from the group consisting of copper, tin, cobalt, nickel, iron, indium, zinc and molybdenum.

5. The tool of claim 4, wherein the total weight of the non-precious metal in the alloy is in the range of 0.001% to 50%.

6. The tool of claim 4, wherein the total weight of the non-precious metal in the alloy is in the range of 0.001% to 10%.

7. The tool of claim 1, wherein the coating has a thickness in the range of 0.001 to 10 microns.

8. The tool of claim 1, wherein the coating has a thickness in the range of 0.001 to 3 microns.

9. A embossing process, which comprises:
a) providing an embossing composition on a supporting layer;
b) providing the embossing tool of claim 1;
c) embossing the embossing composition with the embossing tool;
d) curing or hot embossing the embossing composition after step c); and
e) releasing the embossing tool,

10. The process of claim 9, wherein the adhesion between the embossing tool and the cured embossing composition or hot embossed material is weaker than the adhesion between the supporting layer and the cured embossing composition or hot embossed material.

11. The process of claim 10, wherein the cured embossing composition or hot embossed material is hydrophobic and the supporting layer is hydrophilic, or vice versa.

12. An electrophoretic display film comprising microcells filled with an electrophoretic fluid comprising charged particles dispersed in a solvent or solvent mixture, wherein the microcells are prepared by the embossing process of claim 9.
